(19) United States
(12) Patent Application Publication
(10) Pub. No.: US 2006/0135655 A1
(43) Pub. Date: Jun. 22, 2006

(54) Method for improving filler dispersal and reducing tensile modulus in a thermally conductive polymer composition

(75) Inventor: James D. Miller, Roswell, GA (US)

Correspondence Address: BARLOW, JOSEPHS & HOLMES, LTD., 101 DYER STREET, 5TH FLOOR, PROVIDENCE, RI, 02903, US

(73) Assignee: Cool OPTIONS, Inc.

(21) Appl. No.: 11/295,931

(22) Filed: Dec. 7, 2005

Related U.S. Application Data
(60) Provisional application No. 60/636,750, filed on Dec. 16, 2004.

(51) Int. Cl. C08J 3/22

(52) U.S. Cl. 523/351; 524/425

(57) ABSTRACT

A composition that includes a thermally conductive filler material that is fully wetted out by and encapsulated within a first polymer having a low tensile modulus, which in turn is uniformly dispersed throughout a second polymer resin. Since a low modulus polymer encapsulates the filler material, the interface adhesion between the second polymer resin and the encapsulated thermally conductive additives is improved thereby serving to enhance the mechanical properties of the resulting molded product. Similarly, a method is provided wherein a thermally conductive filler material is fully mixed into a first resin having a low tensile modulus. This resin and filler mixture is then incorporated and uniformly dispersed throughout a second resin to form a highly thermally conductive polymer molding composition.

### CROSS-REFERENCE TO RELATED APPLICATIONS

This application is related to and claims priority from earlier filed U.S. Provisional Patent Application No. 60/636,750, filed Dec. 12, 2004, the contents of which are incorporated herein by reference.

### BACKGROUND OF THE INVENTION

The present invention relates generally to method of improving the dispersal of thermally conductive additives as they are incorporated into thermoplastic resins for the purpose of forming thermally conductive polymer compositions. Further, the present invention is directed to a composition formed in accordance with the above method. More specifically, the present invention relates to a thermally conductive polymer composition and a method of forming a thermally conductive composition whereby the thermally conductive filler is encapsulated in a first polymer material that facilitates the dispersal of the encapsulated filler upon incorporation into a second thermoplastic polymer material.

In the prior art there is a broad range of thermally conductive polymer compositions that are tailored for dissipating heat in many applications. For instance, microelectronic devices such as semiconductors, microprocessors, resistors, circuit boards and integrated circuit elements generate a substantial amount of heat that must be removed in order for the device to function properly. Often thermally conductive polymer compositions are molded into packages for such microelectronic devices. Similarly, thermally conductive polymer composition are also used to make motor parts, lighting fixtures, optical heads, medical devices, and components for use in conjunction with many other heat generating products.

Accordingly, due to the broad range of applications that benefit from the use of molded thermally conductive polymer compositions, manufacturers of molded polymer parts are frequently called upon to prepare objects utilizing a wide variety of different additive modified thermoplastic polymers. In some cases, the manufacture attempts to create the necessary blend of polymer and thermally conductive additive in order to achieve the desired thermal conductivity in the finished part. More commonly however, the manufacturers obtain completed blend formulations from resin suppliers that prepare and supply such completely formulated resin blends that meet the desired criteria set forth as the end use applications of the molder.

In the prior art, such blended resins may be prepared from base polymers including polyethylene, polypropylene, acrylic, vinyl, fluoropolymer, polyamide, polyester, polyphenylene sulfide, and liquid crystal polymer, wherein thermally conductive additives such as metals, metal oxides, ceramics, and carbon materials are mixed throughout the base polymer. Additionally other fillers, such as for example, aluminum, copper, aluminum oxide, magnesium oxide, boron nitride, or graphite particles may be added to the base polymer depending on the intended use of the formulated resin.

While such fully formulated blended resins are generally effective for making thermally conductive molded articles. In some instances, it has been found that transportation, handling and storage of these resins is inefficient and difficult because of the small particulate size of the thermally conductive fillers that are incorporated into the base resin. In other words, the low bulk density of the thermally conductive fillers that are typically used prove quite difficult to handle creating a limitation on the total percentage of solids that can be introduced and reducing the actual line production speed. Further, these small particles may cause the resin to dust, thereby leading to handling and clean-up problems. In addition, if thermally conductive fillers having a relatively large particulate size are used, there can be problems with the bulk-density of the resins. For example, it may be difficult to add thermally conductive fillers having relatively large geometric shapes and structures to the base resin at loadings greater than about 40 to about 50% by weight. Further, such high loading ratios make the final processing of such resins difficult, thereby requiring that the throughput rate of the compounding machines limited to a point that the machines may operate at only 50% capacity in some instances.

Another difficulty arises in that it is often difficult to completely and uniformly disperse the thermally conductive fillers throughout the base polymer because of the chemical structure of these fillers. For example, boron nitride and graphite particles have inert surfaces that cause these fillers to be difficult to wet out and disperse in a base polymer. This is particularly the case when graphite or boron nitride fillers are incorporated into thermoplastic base resins. Thus, it can be difficult to add these thermally conductive fillers in large amounts to the composition. Frequently, because these fillers lack an affinity for traditional thermoplastic resins, when they are incorporated at high filler loadings, the filler material has the tendency to clump. Further, even if the filler is ultimately uniformly dispersed, the filler is not generally wet out by the resin and bond between the inert surfaces of the filler particles and the thermoplastic resin tends to be poor. Additionally, when these high modulus thermally conductive fillers are added to a base polymer that also has a relatively high modulus, the modulus of the composition tends to increase making the finished composition quite brittle. The resulting high modulus compositions may be molded to form an end-use product having good strength and rigidity, however, due to the nature of the filler material used, the product may be too brittle.

In view of the foregoing, there is a need for a new thermally conductive polymer composition that facilities uniform dispersal of thermally conductive fillers throughout the base resin, which can also be molded to form non-brittle products having good strength. Further, there is a need for a thermally conductive polymer composition that has improved bulk density characteristics for improved handling of the raw materials. In addition, there is need for a process wherein a thermally conductive polymer composition can be formed such that the thermally conductive filler material is to fully and efficiently incorporated to create a highly thermally conductive molding material that exhibits a reduction in the brittleness of the finished product.

### BRIEF SUMMARY OF THE INVENTION

In this regard, the present invention provides for both a thermally conductive polymer composition and a method of forming a thermally conductive polymer composition. The composition includes a thermally conductive filler material that is fully wetted out by and encapsulated within a first polymer having a low tensile modulus, which in turn is uniformly dispersed throughout a second polymer resin. The composition of the present invention provides several advantages over the thermally conductive polymer composition of the prior art. Principally, since a low modulus polymer encapsulates the filler material, the interface adhesion between the second polymer resin and the encapsulated thermally conductive additives is improved. This improvement in adhesion serves to enhance the mechanical properties of the resulting molded product in that the well-adhered additives are less likely to act as voids or weak points in the molded product. Also, this encapsulating mechanism means that the effects of the high modulus, stiff additives can be mediated by the surrounding layer of soft, low modulus resin.

In addition, by fully and uniformly dispersing the thermally conductive filler materials into a first low modulus polymer, the thermally conductive additives are fully wetted out in a manner that allows them to better disperse in the second molding polymer. When incorporating the additives in this manner, they are less likely to aggregate and form clumps.

In accordance with the method of the present invention, a thermally conductive filler material is provided. The thermally conductive filler material is then fully mixed into a first resin having a low tensile modulus. The filler material is mixed into the first polymer until the filler material is fully wetted out and the particles of filler material are encapsulated by the low modulus resin. This resin and filler mixture is then incorporated and uniformly dispersed throughout a second resin to form a highly thermally conductive polymer molding composition.

In this manner, the present invention provides a composition that offers a unique solution for overcoming the traditional bonding issue that is encountered when thermally conductive additives are dispersed into a polymer resin. Specifically, by first encapsulating the filler particles with a low modulus polymer, the challenges found in the prior art regarding handling a material having a low bulk density and an increased brittleness in the finished composition are overcome in that the filler is wetted out and bonded to the polymer encapsulant. The second benefit that is achieved is a decrease in the effective compound stiffness once the encapsulated filler is incorporated into the second molding polymer material because the encapsulant material introduces a uniform dispersal of low modulus inclusions throughout the composition.

Accordingly, it is an object of the present invention to provide a thermally conductive molding composition that exhibits improved wet out and dispersal of the thermally conductive filler that is loaded therein. It is a further object of the present invention to provide a thermally conductive polymer molding composition that improves the overall material properties of the finished part by encapsulating the thermally conductive filler material with a low modulus polymer resin prior to incorporating the encapsulated filler into the base thermoplastic resin. It is still a further object of the present invention to provide a method of forming a thermally conductive polymer molding composition that encapsulates the thermally conductive filler material prior to its incorporation into a thermoplastic resin thereby overcoming the traditional lack of affinity between the filler material and the thermoplastic resin.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying descriptive matter in which there is illustrated and described a preferred embodiment of the invention.

### DETAILED DESCRIPTION OF THE INVENTION

The present invention provides a thermally conductive composition and a method of forming a thermally conductive composition that allows fillers having a low bulk density and a general lack of affinity for thermoplastics to be first encapsulated in a low tensile modulus first polymer material and then fully dispersed throughout a second thermoplastic resin. In this manner the composition includes a thermally conductive filler material that is fully wetted out by and encapsulated within a first polymer which is in turn uniformly dispersed throughout a second polymer resin.

The composition of the present invention generally includes a thermally conductive filler material, a first encapsulant resin and a second base resin, wherein the thermally conductive filler material is encapsulated and fully wetted out by the first resin.

The encapsulated filler material is then uniformly dispersed throughout the second resin to form a highly thermally conductive polymer composition suitable for further processing such as in net-shape molding operations.

With regard to the first encapsulant resin, any suitable polymer having a relatively low tensile modulus can be used to encapsulate the thermally conductive filler material provided that the filler and polymer resin have an affinity for one another. In other words, any low tensile modulus polymer can be utilized within the scope of the present invention as an encapsulant material provided it is capable of dispersing and fully wetting out the thermally conductive filler material. The encapsulant polymer should have a tensile modulus of no greater than about 1500 MPa, and preferably no greater than 500 MPa. More preferably, the tensile modulus of the encapsulant polymer is less than 300 MPa. Further, it is preferable that the encapsulant polymer be capable of maintaining its low tensile modulus properties at reduced and elevated temperatures.

Some examples of suitable encapsulant polymers may include for example elastomers such as styrene-butadiene copolymer, polychloroprene, nitrile rubber, butyl rubber, polysulfide rubber, ethylene-propylene terpolymers, polysiloxanes (silicones), and polyurethanes. It is also contemplated that thermoplastic elastomers may be used as the encapsulant polymer. Thermoplastic elastomers are generally low modulus, flexible materials that can be stretched repeatedly and are able to retract to their original length when released. Thermoplastic elastomers are generally known materials and comprise a hard, thermoplastic phase coupled mechanically or chemically with a soft, elastomeric phase. Suitable thermoplastic elastomers include, for example, copolymers selected from the group consisting of styrenic copolymers such as styrene-butadiene-styrene (SBS), styrene-ethylene/butylene-styrene (SEBS), styrene-isoprene-styrene (SIS), and styrene-ethylene/propylene-styrene (SEPS); polyester copolymers; polyurethane copolymers; and polyamide copolymers. In one preferred embodiment, the base polymer used as the encapsulant is nitrile butadiene rubber (NBR). In another preferred embodiment, the base polymer used as the encapsulant is thermoplastic polyester elastomer.

In forming the composition, thermally conductive additives or fillers are dispersed throughout and encapsulated by the first polymer material. Suitable thermally conductive filler materials, for example, metals such as aluminum, copper, gold, silver, nickel, magnesium, zinc, and brass; metal oxides such as alumina, magnesium oxide, zinc oxide, and titanium oxide; ceramics such as silicon nitride, aluminum nitride, boron nitride, and boron carbide; and carbon materials such as carbon black and graphite; and the like. Mixtures of such thermally conductive fillers are also suitable. The thermally conductive filler can be in the form of particles, granular powder, whiskers, fibers, or any other suitable form. The particles or granules can have a variety of structures and a broad particle size distribution. For example, the particles or granules can have flake, plate, rice, strand, hexagonal, or spherical-like shapes. In one preferred embodiment the filler is a carbon material in the form of a carbon graphite powder having an average particle size of greaterthan 500 microns. In another preferred embodiment the filler is boron nitride having an average particle size of less than 10 microns.

Preferably, the thermally conductive additive has an inherent thermal conductivity of at least 8 W/m°K. More preferably, the thermally conductive additive has an inherent thermal-conductivity of at least 25 W/m°K, and in some embodiments, the thermal conductivity is greater than 100 W/m°K. Generally, the thermally conductive additive is blended into the first encapsulant resin in an amount of at least 70% by weight based on total weight of the combined first resin and thermally conductive filler. Preferably, the thermally conductive additive is present in an amount greater than 75% by weight and more preferably greater than 80% by weight. Loadings of the thermally conductive additive in the encapsulant resin can be as high as 90% by weight. Accordingly this leaves an encapsulant resin loading ratio of between 10% and 30%

It is also recognized that a second additive such as plasticizers, oils, stabilizers, antioxidants, dispersing agents, coloring agents, mold-releasing agents, curing agents, lubricants, and the like can be added to the encapsulant resin composition. More particularly, the modulus of the encapsulant resin can be lowered by adding plasticizers, lubricants, oils, and like additives. These plasticizers and other additives can be added to make the resin surrounding the thermally conductive additives more flexible. In one preferred embodiment, the initial filler and first resin mixture also contains about 10% to about 15% by weight of a plasticizer based on total weight of the combined filler and encapsulant resin composition.

In an initial compounding step the thermally conductive additive is combined with the encapsulant resin, to form an intermediate mixture. The intermediate mixture can be prepared using known melt-compounding techniques. The thermally conductive additives, and any second additives (if present) are intimately mixed with the encapsulant polymer such that the thermally conductive additive is uniformly dispersed throughout the encapsulant resin. Further, the thermally conductive filler particles are encapsulated and fully wetted out by the encapsulant resin. Conventional mixing and compounding equipment such as a Banbury mixer, roll mixer, continuous mixer, single or twin screw extruder, kneader, or the like can be used to compound the intermediate mixture. The compounded intermediate mixtures can be produced in any suitable form. For example, the intermediate mixtures can have strand, sheet, pellet, crumb-like granular, or particulate structures.

The resulting intermediate mixture itself has many advantageous properties. For instance, the intermediate mixture provides a way for making molding compositions having high loadings of thermally conductive additives. The intermediate mixture is loaded preferably with thermally conductive additives in an amount of at least 70% by weight and more preferably up to 90% by weight.

In finished form, the intermediate mixture is blended with a second resin to make a molding composition as described in further detail below. The second resin should be compatible with the intermediate mixture of thermally conductive material so that these materials can be combined to form a uniformly, well-dispersed molding composition. Suitable base polymers that can be used as the second resin include thermoplastics such as, for example, polyethylenes, polypropylenes, acrylics, vinyls, fluoropolymers, polyamides, polyesters, polyphenylene sulfide, and liquid crystal polymers such as thermoplastic aromatic polyesters. Alternatively, thermosetting polymers such as thermosetting elastomers, epoxies, polyesters, polyimides, and acrylonitriles may be used. The second resin may include elastomers such as styrene-butadiene copolymer, polychloroprene, nitrile rubber, butyl rubber, polysulfide rubber, ethylene-propylene terpolymers, polysiloxanes (silicones), and polyurethanes. It is also contemplated that thermoplastic elastomers as well as polyetheretherketone (PEEK), as discussed above as encapsulants, may be used as the second resin.

The second resin preferably does not contain any additives although it is possible that additives for strength enhancement may be added such as crushed glass. The second resin is generally an unmodified resin that is used for incorporation of the initial mixture in a manner that provides the necessary temperature stability, environmental resistance and overall strength found in the final composition. The second resin and initial mixture are blended together at approximately 20% to 80% by weight initial mixture and approximately 20% to 80% secondary resin to form a thermally conductive molding composition. Known blending and compounding methods can be used to produce the thermally-conductive molding composition. For example, the thermally-conductive composition can be compounded using dry-blending, extrusion-blending or other conventional techniques. In one embodiment, the molding composition is pelletized so that it is in pellet form. It is recognized that the molding composition can be compounded into a form other than pellets. For example, the molding composition can be compounded so that it has a strand-like structure. Then, the molding composition can be used in an injection molding or other molding process to form a molded product.

Because the lightweight fine particulate filler material has been fully encapsulated, the molding composition has a relatively high bulk density, since it is highly filled with the thermally conductive additives from the intermediate mixture. The throughput rates and capacity levels of the molding machines can be increased by using these highly loaded molding compositions. Secondly, the thermally conductive additives are fully and uniformly dispersed in the intermediate mixture. Since the thermally conductive additives were previously fully wetted out by the encapsulant resin the difficulties previously encountered wherein the thermally conductive additives and thermoplastic remolding resins lacked an affinity is overcome, so that in accordance with the present invention, the encapsulated particles can better disperse uniformly throughout the base polymer. In this manner, the additives are less likely to aggregate and form clumps.

By forming the molding composition in accordance with the teachings of the present invention the material properties of the overall composition can be greatly improved. This is principally the result of the relatively low modulus base resin encapsulating the relatively high modulus thermally conductive additives. Typically, thermoplastic molding resins do not wet out or adhere well to the particles of the thermally conductive additives thereby causing poor interface adhesion and a brittle finished composition. However, since the thermally conductive particles are encapsulated in the first resin, the interface adhesion is between the first and second resins and not the thermally conductive particles. This adhesion helps enhance some mechanical properties of the resulting molded product. The well-adhered additives are less likely to act as voids or weak points in the molded product. Also, this encapsulating mechanism means that the effects of the high modulus, stiff additives can be mediated by the surrounding layer of soft, low modulus resin.

In preparing the final molding composition, the thermally conductive additive is present in the molding composition in an amount in the range of about 10% to about 60% by weight based on the total finished weight of the overall molding composition, and preferably, the thermally-conductive additive is present in an amount of about 20% to about 50%.

Conventional injection-molding machines can be used to mold the thermally conductive molding composition into a finished product. Injection-molding processes are known in the industry and generally involve feeding pellets of the molding composition into a hopper. The hopper funnels the pellets into a heated extruder (barrel), wherein the pellets are heated to form a molten composition (liquid plastic). The extruder then feeds the molten polymer into a chamber containing an injection piston. The piston moves forward and forces a shot of the molten composition into a mold. The mold typically contains two molding sections that are aligned together in such a way that a molding chamber or cavity is located between the sections. The molten material remains in the mold under high pressure until it cures and cools. Then, the molded product is removed. It also is recognized that other molding processes such as extrusion, casting, and blow-molding can be used to make the molded product.

The molding composition can be molded to form a wide variety of thermally conductive products such as packaging for electronic devices, lighting fixtures, optical heads, and medical devices. Preferably, the resulting molded product has a thermal-conductivity of at least about 1.0 W/m°K and more preferably the product has a thermal-conductivity greater than 3.0 W/m°K. The thermal-conductivity of the molded product is typically in the range of about 1.0 to about 30.0 W/m°K.

The following are some examples of intermediate mixtures made in accordance with this invention.

### EXAMPLES

1. An intermediate mixture comprising about 79% by weight carbon graphite having an average particle size of greater than 500 microns and 21% by weight NBR (nitrile butadiene rubber with 10% by weight DOS (dioctyl succinate plasticizer)) was prepared.
2. A thermally-conductive intermediate mixture comprising about 74% by weight boron nitride having an average particle size of less than 10 microns and 21% by weight NBR (nitrile butadiene rubber with 10% by weight DOS (dioctyl succinate plasticizer)) was prepared.
   It should be appreciated by one skilled in the art that the above examples are meant only to illustrate some intermediate mixtures that can be made in accordance with this invention, and these examples should not be construed as limiting the scope of the invention. The intermediate mixtures are then blended with a suitable second resin to form a finished molding composition and to mold a finished article.

In accordance with the method of the present invention, a thermally conductive filler material is provided. As stated above, the filler is selected from any one of the materials identified as being suitable to form such a thermally conductive composition although preferred materials include carbon graphite and boron nitride powders. The thermally conductive filler material is then fully mixed into a first resin having a low tensile modulus. Again, the first encapsulant resin is selected from the grouping identified above and is preferably NBR or thermoplastic polyester elastomer. The filler material is mixed into the first polymer until the filler material is fully wetted out and the particles of filler material are encapsulated by the low modulus resin. This resin and filler mixture is then incorporated and uniformly dispersed throughout a second resin to form a highly thermally conductive polymer molding composition.

In this manner, it can be seen that the present invention provides a thermally conductive polymer composition and method of forming a composition that offers a unique solution for overcoming the traditional bonding issue that is encountered when thermally conductive additives are dispersed into a polymer resin. Specifically, by first encapsulating the filler particles with a low modulus polymer, the challenges found in the prior art regarding handling a material having a low bulk density and an increased brittleness in the finished composition are overcome in that the filler is wetted out and bonded to the polymer encapsulant. The second benefit that is achieved is a decrease in the effective compound stiffness once the encapsulated filler is incorporated into the second molding polymer material because the encapsulant material introduces a uniform dispersal of low modulus inclusions throughout the composition. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A thermally conductive polymer composition comprising:
between 10% and 60% thermally conductive filler material;
a first encapsulant resin; and
a second resin,
wherein said thermally conductive filler material is fully wetted out and encapsulated by said first encapsulant resin to form a thermally conductive initial mixture, said initial mixture being uniformly dispersed throughout said second resin.

2. The thermally conductive composition of claim 1, wherein said thermally conductive filler material is selected from the group consisting of: metals, metal oxides, ceramics, carbon materials and mixtures thereof.

3. The thermally conductive composition of claim 1, wherein said thermally conductive filler material is carbon graphite powder.

4. The thermally conductive composition of claim 1, wherein said thermally conductive filler material is boron nitride.

5. The thermally conductive composition of claim 1, wherein said encapsulant resin is nitrile butadiene rubber (NBR).

6. The thermally conductive composition of claim 1, wherein said encapsulant resin is thermoplastic polyester elastomer.

7. The thermally conductive composition of claim 1, wherein said thermally conductive filler is present in said thermally conductive initial mixture at between 70% and 90% by weight.

8. The thermally conductive composition of claim 1, wherein said thermally conductive filler is present in said molding composition at between 10% and 60% by weight.

9. The thermally conductive composition of claim 1, wherein said thermally conductive initial mixture further includes a plasticizer.

10. A thermally conductive polymer composition comprising:
a thermally conductive initial mixture including:
between 70% and 90% thermally conductive filler material, and
between 10% and 30% first encapsulant resin,
wherein said thermally conductive filler material is fully wetted out and encapsulated by said first encapsulant resin; and
a second resin, wherein said thermally conductive initial mixture is uniformly dispersed throughout said second resin.

11. The thermally conductive composition of claim 10, wherein said thermally conductive filler material is carbon graphite powder.

12. The thermally conductive composition of claim 10, wherein said thermally conductive filler material is boron nitride.

13. The thermally conductive composition of claim 10, wherein said encapsulant resin is nitrile butadiene rubber (NBR).

14. The thermally conductive composition of claim 10, wherein said encapsulant resin is thermoplastic polyester elastomer.

15. The thermally conductive composition of claim 10, wherein said thermally conductive initial mixture further includes a plasticizer.

16. A method of forming a thermally conductive composition comprising the steps of:
providing a thermally conductive filler material;
mixing said thermally conductive filler material into a first encapsulant resin, wherein said thermally conductive filler material is fully wetted out and encapsulated by said first encapsulant resin to form a thermally conductive initial mixture; and
mixing said thermally conductive concentrate into a second resin to form a thermally conductive molding composition.

17. The method of claim 16, wherein said thermally conductive filler material is carbon graphite powder.

18. The method of claim 16, wherein said thermally conductive filler material is boron nitride.

19. The method of claim 16, wherein said encapsulant resin is nitrile butadiene rubber (NBR).

20. The method of claim 16, wherein said encapsulant resin is thermoplastic polyester elastomer.

21. The method of claim 16, wherein said thermally conductive initial mixture further includes a plasticizer.
